(19) United States
(12) Patent Application Publication
(10) Pub. No.: US 2007/0089030 A1
(43) Pub. Date: Apr. 19, 2007

(54) Configurable bandwidth allocation for data channels accessing a memory interface

(76) Inventors: Alejandro Lenero Lenero Beracoechea, Dublin, CA (US); Jing Ling, Freemont, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/241,356

(22) Filed: Sep. 30, 2005

(51) Int. Cl. H03M 13/00

(52) U.S. Cl. 714/762

(57) ABSTRACT

An apparatus and a method for flexibly configuring memory bandwidth allocations for different data channels is described. In one embodiment, the invention includes receiving data from a data communications channel, storing the data in a buffer, upon accumulating a predefined amount of data from the channel, determining a base address of a partition of a memory associated with the data communications channel, and storing a burst of the stored data in the memory partition.

### FIELD

The present description relates to the field of allocating resources to memory partitions in a data communications appliance and in particular to flexibly allocating memory bandwidth to data communications channels that have different bandwidth requirements.

### RELATED ART

In a data communication system, data is transferred between devices in bursts. The size of the burst and how quickly the bursts may be sent determines the flow rate of the data. Standards are established that determine the size, format, frequency, content and other aspects used for communicating data bursts, but the standards are not consistent. Some overlap or cover different aspects of the communication and others are in competition. Such standards presently include Ethernet, Fiber Channel, FICON (Fiber Connectivity from IBM), ESCON (Enterprise Systems Connectivity from IBM), FDDI (Fiber Distributed Data Interface from ANSI), and SONET (Synchronous Optical Networking from Telcordia), among others. More standards are under development and still will be introduced later.

In order to send data bursts over the transmission lines, the data must be readied for transmission in some type of buffer. From the buffer, the data may be sent with the speed, size and timing that the particular communications standard requires. Similarly receive data must be buffered so that it can be received at the speed, size and timing of the communication system and then processed by the receiver on its own schedule.

In order to store data for clients on the system and to allow flow control over long distances, a large external RAM (e.g., DDR SDRAM (Double Data Rate Synchronous Dynamic Random Access Memory)) is typically used. The usable bandwidth of a SDRAM can be increased significantly (as compared with random access) by identifying independent flows with equal bandwidth and then using a deterministic bank interleaving algorithm. Bandwidth in the present context refers to the rate at which data may be read from or written to the SDRAM. Bank interleaving is a common method to increase memory efficiency in packet processing, but it only provides the greatest efficiency when the network data arrives in even patterns.

Another approach to increasing the bandwidth efficiency of SDRAM is rearranging random memory access to avoid consecutive reads or writes to the same bank. This is mostly used in traffic managers or network processors, where deterministic flow identification is not possible. Rearranging accesses allows for an increase in bandwidth usage statistically, but does not guarantee any access efficiency level and requires a more complex implementation (for rearranging the read/write accesses).

Given the variety of different standards, a single computer, router, network processor, or network interface card may be required to be compatible with different standards. This may be done by using different hardware for each standard but that increases costs. In such a system, data clients might have different bandwidth requirements ranging from a couple hundred Mbits/sec (e.g. Megabit Ethernet, USB (Universal Serial Bus), Firewire, 802.11g (from IEEE)) to a couple of Gbits/sec (e.g., Fibre Channel, FICON, FDDI, Gigabit Ethernet, etc.) or more. Depending on the system requirements, multiple data rate hardware would need to store a combination of different types of data clients and the types in the combination may change.

To identify independent flows with equal bandwidth, one approach is to use the highest bandwidth for all types of traffic flows. However, if most flows in the system are of lower bandwidth (e.g., 200 Mbps ESCON vs. 1700 Mbps Fibre Channel data), then this approach will be very expensive and the lower bandwidth flows will waste a significant amount of the available memory.

### BRIEF DESCRIPTION OF THE DRAWINGS

Embodiments of the present invention will be understood more fully from the detailed description given below and from the accompanying drawings of various embodiments of the invention. The drawings, however, should not be taken to be limiting, but are for explanation and understanding only.

FIG. 1 is a block diagram of client adaptation module according to an embodiment of the invention;

FIG. 2 is a block diagram of the channel ingress side of the client adaptation module of FIG. 1 according to an embodiment of the invention;

FIG. 3 is a block diagram of the channel egress side of the client adaptation module of FIG. 1 according to an embodiment of the invention;

FIG. 4 is a process flow diagram of writing data into an external memory according to an embodiment of the invention;

FIG. 5 is a process flow diagram of reading data from an external memory according to an embodiment of the invention; and

FIG. 6 is a block diagram of a high speed data communications network processor incorporating the client adaptation module of FIG. 1 according to an embodiment of the invention.

### DETAILED DESCRIPTION

When there are independent data flows with deterministic bandwidth and when large external storage is required, for example in flow control over long distances, memory usage and speed may be improved by allowing each client to use only the actual bandwidth needed. For optimal efficiency, each client uses the bandwidth that comes as close as possible to the actual bandwidth needed, yet the high bandwidth usage of the SDRAM is maintained. Memory usage may be further improved by changing the bandwidth allocation for a specific client if the bandwidth needs of the client changes (due, for example, to a change of the type of traffic of the client). The use made of device resources is improved and there is flexibility to combine clients with different bandwidth requirements. Clients may also be changed with only a few small changes to configuration settings.

According to some embodiments of the invention, the access efficiency to SDRAM is improved using a deterministic approach, while bandwidth assignments may flexibly be reconfigured to different data channels. In the described implementation, the bandwidth associated with a channel may be reconfigured, allowing different clients to be accommodated. This flexibility and efficiency is particularly applicable to transporting data clients over long distances, where the number of data clients (flows) is limited (in the range of a few dozens to hundreds, as compared to the number of flows in a network processor, i.e., thousands or more) and the bandwidth for each flow is deterministic. However, it may be adapted to many other applications.

Embodiments of the present invention may be applied to independent data flows with known bandwidth, where an interleaving pattern is already available, and where very high memory bandwidth can be obtained easily in a deterministic way. A different bandwidth may be configured for each data channel and the channel bandwidth may be reconfigured as needed. As a result, a mix of different types of data clients may be transported and the types of data clients for each port may be changed on the fly.

The designs described herein allow modification of the channel bandwidth that is accessing an external DDR-SDRAM by changing the configuration of the channel bandwidth. In the described example, this is achieved using a look up table containing 2ⁿ partitions (where n>1). In the described example, n=3 so there are 8 partitions. Each partition corresponds to a reserved space within the external memory and corresponds to one SDRAM page. Each partition may be linked to any channel by the configuration of the look-up table. An example of a look up table is provided in Table 1. Table 1 associates each partition with a communications channel. Each channel may have the same or different bandwidth requirements.

TABLE 1

| Partition | Channel |
|---|---|
| 0 | 0 |
| 1 | 0 |
| 2 | 1 |
| 3 | 2 |
| 4 | 3 |
| 5 | 4 |
| 6 | 3 |
| 7 | 4 |

The SDRAM page size is limited by the size of the SDRAM and the number of partitions defined for it. The memory space associated with a channel depends on the memory size and the number of partitions that are assigned to the channel. A channel, however, may be assigned to as many partitions as needed to fill the channel or as many partitions as desired based on other system design considerations. The bandwidth that a partition can handle may be fixed and is obtained from the following equations:
partition bandwidth=total bandwidth/total number of partitions total bandwidth=(64*bus_width*refresh_period*clkfreq)/(refresh_period(128+Twr2rd+Trd2wr−1)+Trd2ref+refresh_length)
where,

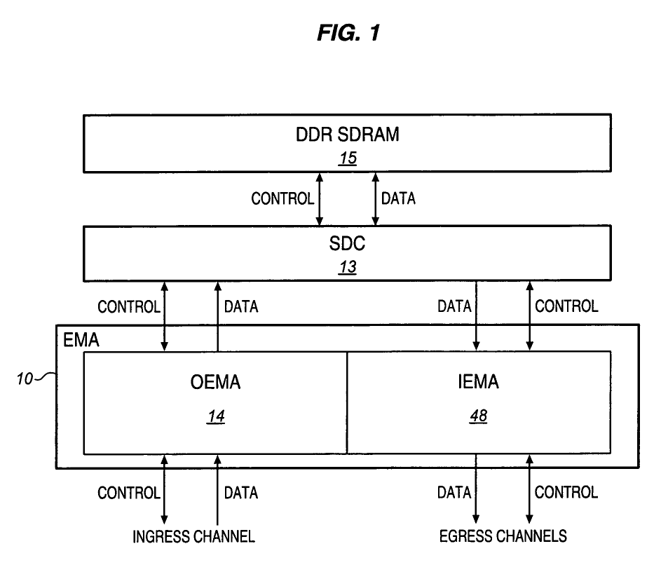

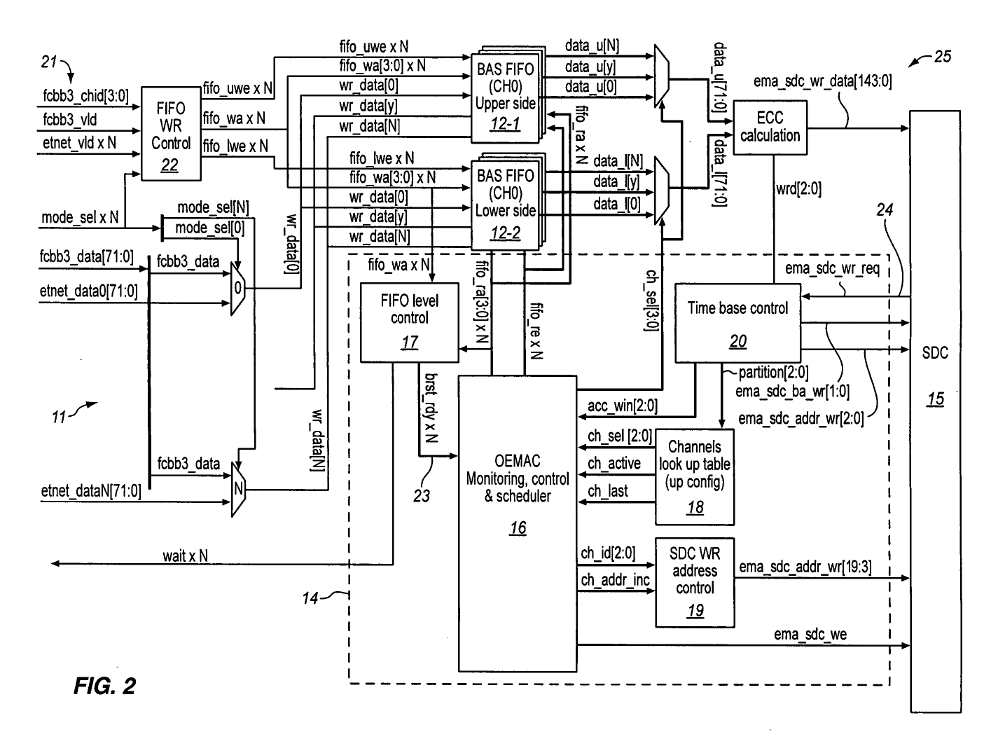

bus_width: is the width of the data bus at the interface between EMA (External Memory Access) and SDC (SDRAM Controller) blocks (See e.g. FIGS. 1 and 2), for example 144 bits.

refresh_period: is the number of write/read operation blocks that can be sustained by the SDRAM between memory refresh operations, for somewhere in the range 1 to 127.

clkfreq: is the clock frequency.

Twr2rd: is the transition time from the write request block to the read request block in the SDC, for example from 5 to 20 clock cycles.

Trd2wr: is the transition time from the read request block to the write request block in the SDC, for example from 5 to 20 clock cycles.

Trd2ref: is the transition time from the read request block to the start of a refresh operation in the SDC, for example from 5 to 20 clock cycles.

refresh-length: is the time that the SDC block spends on the refresh operation of the external memory, for example from 5 to 37 clock cycles).

64 represents the number of 144-bit words that can be written into the SDRAM with each write cycle based on 16 bursts of 4 144-bit words each.

128 represents the 64 144-bit words in each read cycle and the 64 144-bit words in each write cycle. With different memory types and protocols, these values may differ.

Each channel may be assigned multiple partitions so that the bandwidth of any one channel is equal to the product of the number of partitions in the channel and the bandwidth of each partition.

For example in one example, the following values are assigned:

Twr2rd=Trd2wr=Trd2ref=5

clkfreq=175 Mhz

refresh_period=10

refresh-length=5

total number of partitions=8

This gives a total (usable) bandwidth of 10.16 Gbits/sec and a partition bandwidth of 1.46 Gbits/second. A channel with a higher bandwidth requirement than 1.46 Gbits/sec needs to use two (or more) partitions. In this case, a two-partition channel might handle 2.92 Gbits/sec. More partitions allow for even higher bandwidth channels.

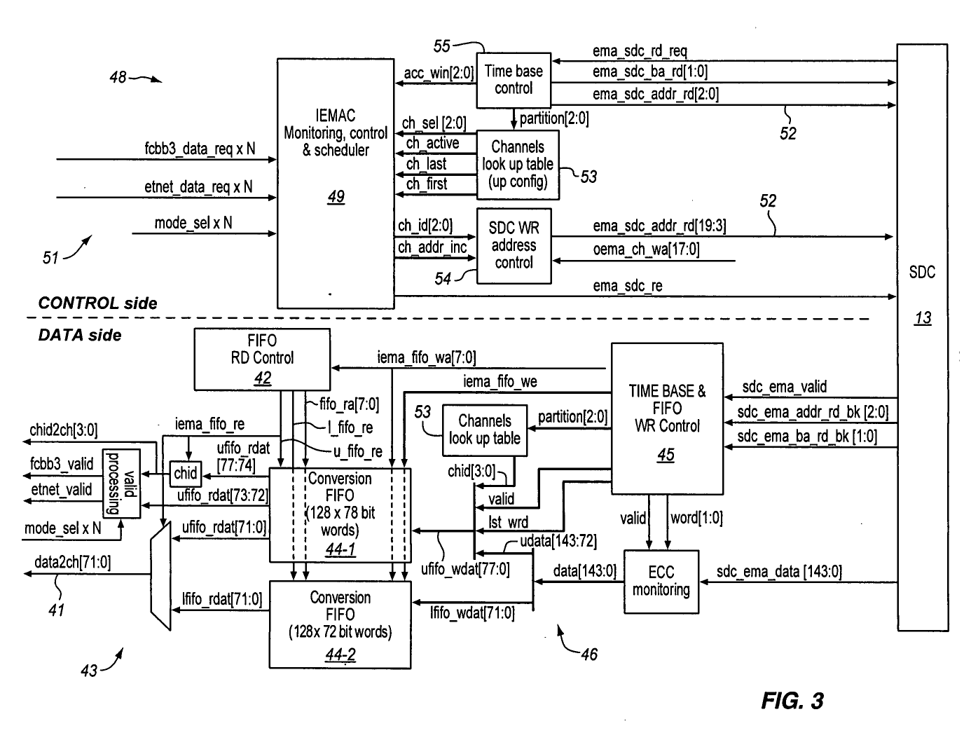

FIG. 1 shows hardware elements that may be used as part of flexibly allocating channel bandwidth using EMA (External Memory Access). FIG. 2 shows the OEMA (Output EMA) block (write side of the SDRAM) with related components and FIG. 3 shows the IEMA (Input EMA) block (read side of the SDRAM) with related components. The SDRAM and SDRAM Controller in the two figures is the same.

FIG. 1 shows a generalized block diagram of a communications transport device suitable for applications of the present invention. In FIG. 1, communication channels are coupled through an EMA (External Memory Access) 10 and a SDC (SDRAM Controller) 13 to an external memory 15 in the form of a DDR SDRAM. The components are all coupled using control and data lines. While a DDR SDRAM is shown this is intended only as an example. Any other type of memory with suitable speed and capacity may be used. The EMA has an Output EMA 14 on the ingress side and an Input EMA 48 on the egress side. Data is received through ingress channels at the OEMA 14 and written into the memory. Data is sent out through egress channels after being written from the memory to the IEMA.

In FIG. 2, data streams in from external channels 21 through a FIFO write controller 22 of a data port 11 to either one of two BAS FIFOs (Burst Assembly First In First Out Registers) 12. In the FIG. 2 example, there is one BAS FIFO per channel (upper 12-1 and lower 12-2). The data is temporarily stored in these FIFOs until there is enough data to be written into the SDRAM 13. The FIFOs have data output ports 25 through which they are connected to the SDC block (SDRAM Controller) 13 to send data. An OEMA (Output External Memory Access) 14 is coupled to the FIFOs and the data lines to handle write requests from an SDC block 13.

The OEMA includes a OEMAC (OEMA Controller) 16 coupled to the FIFOs for monitoring, control and scheduling of write operations to the SDRAM. The OEMAC receives a burst ready (brst_rdy) signal 23 from a FIFO level control block 17 that monitors the data streaming into the FIFOs. The OEMAC is also coupled to channel look-up tables 18, described in more detail below, and to an SDC write address control block 19 to allocate addresses within the SDRAM. A time base controller 20 provides timing signals to the OEMAC and SDC block, among others.

The SDC block (SDRAM Controller) 13 interfaces the OEMA 14 with the SDRAM 15 by scheduling the memory accesses and generating the control signals to interface with the SDRAM. The SDC block generates write and read requests by blocks. In one example, each block has 16 write requests followed by 16 read requests. Each request is spaced by 4 clock cycles and processes a whole data burst per operation. A burst contains a predetermined number of words and each word contains a predetermined number of bits. The burst in this example has eight 72 bit words interfacing with 144 bit words in the interface with the OEMA. The particular numbers for bits and words may be adapted to suit a particular implementation. The SDC block may also schedule and generate operation and maintenance commands for the SDRAM such as auto pre-charge and refresh periods.

A process for reading data from the external data channels into the SDRAM may start in the OEMA 14 when external data channels (such as Ethernet or Fibercon) start writing data words into the corresponding BAS FIFOs, these words are stored until the BAS FIFO contains enough data words to be written into the SDRAM memory. When this happens the FIFO level control will detect the level of data in the FIFOs and assert a burst ready signal 23 to the OEMAC. In the described example, a data word is defined to be 72 bits of information; however different size words may be selected as appropriate for a particular implementation.

In one embodiment, the channel BAS FIFO may be configured to declare that it has enough words stored when it has at least as many data bursts as it has partitions assigned to it or associated with it. For example, a channel may be associated with a maximum of 2 partitions, so that “burst ready” is asserted when there are at least 2 data bursts (2×8×72 bit words), each burst filling a partition.

The assertion of a “burst ready” signal for a specific channel may be interpreted as a write command from the channel. The corresponding FIFO then enters a wait state until a write request 24 is received from the SDC block for that channel. The write request is sent to the time base controller and then through the OEMAC to control the FIFOs. When the write request is served, the stored bursts of data are extracted from the BAS FIFOs and then provided to the SDC block to be written to the external SDRAM over the data channels.

When an opportunity access to the SDRAM (write or read) is granted to a partition, a whole data burst (e.g. 8×72 bit words) is written to (or read from) the SDC (SDRAM Controller) block after a 72 to 144 bit conversion. This operation may be performed in 4 clock cycles that define a partition access window. Once the 4 cycle burst read or write is complete, the access opportunity is given to the next partition. This is repeated until the last partition has been accessed. It may then start over again with the first partition. If there are eight partitions, then the partition counter goes from 0 to 7. In general, the partition count from 0 to 2ₙ-1 may be defined as a “partition cycle”. A partition cycle is represented in the next two tables.

Table 2 represents an example of the data words that may be accessed in partitions 0 and 1, respectively, in each access window. Table 3 represents an example of the data words that may be accessed in the last (2n-1) and then again the first (0) partition in each access window.

TABLE 2

| | Data Words | | | | | | | |
|---|---|---|---|---|---|---|---|---|
| | 0 & 1 | 2 & 3 | 4 & 5 | 6 & 7 | 0 & 1 | 2 & 3 | 4 & 5 | 6 & 7 |
| Access | 0 | 1 | 2 | 3 | 0 | 1 | 2 | 3 |
| Window | | | | | | | | |

| | | |
|---|---|---|
| Partition | 0 | 1 |

TABLE 3

| | Data Words | | | | | | | |
|---|---|---|---|---|---|---|---|---|
| | 0 & 1 | 2 & 3 | 4 & 5 | 6 & 7 | 0 & 1 | 2 & 3 | 4 & 5 | 6 & 7 |
| Access | 0 | 1 | 2 | 3 | 0 | 1 | 2 | 3 |
| Window | | | | | | | | |

| | | |
|---|---|---|
| Partition | 2ⁿ − 1 | 0 |

The use of bandwidth while accessing the SDRAM may be further optimized by associating partitions with particular memory banks of the SDRAM. In one embodiment, each partition may be associated with a bank in a round robin fashion, cycling through the banks repeatedly until each partition is assigned. If the SDRAM has four memory banks, then the bank number for each partition may be assigned as the partition number modulo four. This is shown in Table 4 for eight partitions and four banks. Such an approach obtains the benefit of any bank interleave capability that the SDRAM may have. The configuration of Table 4 may be adapted to accommodate any other type of bank interleaving of other memory addressing system.

TABLE 4

| Partition | Bank |
|---|---|
| 0 | 0 |
| 1 | 1 |
| 2 | 2 |
| 3 | 3 |
| 4 | 0 |
| 5 | 1 |
| 6 | 2 |
| 7 | 3 |

At the beginning of the partition cycle, i.e. cycling write commands through all of the partitions as shown, for example in Tables 2 and 3, the write commands (brst_rdy, in OEMA side) are captured for all of the channels. These are maintained in a captured state during the whole partition cycle. Capturing the write commands for all of the channels at the beginning of the partition cycle synchronizes the channel write base address for all channel accesses within the partition cycle. The channel base address is used for the particular write to the external memory. Capturing the write commands also allows the order in which the data is written into the external memory to be tracked. Capturing all the write command during the whole partition cycle, allows all the partitions associated with any one particular channel to extract a data burst during the cycle.

To ensure synchronization among multiple partitions assigned to the same channel, the burst ready signal for each channel can be declared in different ways. In one example, the burst ready signal can be declared if the BAS FIFO has at least as many data bursts as the maximum number of partitions that can be assigned to a channel. This is a simple determination, but for channels that do not use the maximum number of partitions, there will be delays for the information stored in the BAS FIFO in the OEMA block (extra latency). To reduce this latency, some extra logic may be added to declare the burst ready signal depending on the number of partitions actually assigned to a channel.

In one example, a partition is granted write access to the external memory if, for the associated channel: a) the captured write command is asserted, b) the partition count matches the partition to execute the access, c) the partition is configured as active, and d) a write request command is received from the SDC block. Any one or more of these conditions may be deleted and others may be added. In one embodiment, when all these conditions are met, an address to the channel is generated.

The partition count (see Table 4) is used as a read address for the look-up table 18. The look-up table provides a channel active field and a channel ID field. The channel active field indicates that the partition is an active channel partition (i.e. not an unused one). The Channel ID is used to control the data multiplexer at the output of the channel BAS FIFOs and to extract the channel base address to be used for the write operation. The channel base address is used for the particular write to the external memory. The base address may be the same for two or more pages of the memory, meaning that two partitions can write to the same base address but to a different page.

After the table look up, the corresponding control signals, address lines and data are forwarded to the SDC block which adapts the signals and executes the write operation into the external memory. If a channel performs a write operation within the partition cycle, the corresponding write base address is incremented by one leaving it ready for the next write operation to be performed for that channel with the next cycle.

FIG. 3 shows hardware elements for an input side memory access. This hardware allows data stored in the external SDRAM memory to be provided to the communications channels. In FIG. 3, data streams out to external communications channels 41 under the control of a FIFO read controller 42 of a data port 43. The data is delivered from either one of two conversion FIFOs 44-1, 44-2. In the FIG. 3 example, the data is temporarily stored in these FIFOs for conversion from 144 bit to 72 bit words. Under control of a Time Base and Write Control block 45, the FIFOs can receive data from the SDRAM controller through data input ports.

An IEMA (Input External Memory Access) 48 is coupled to the SDC block 13 to receive read requests and control the channel read commands from the communication channel interface to the SDRAM. It also processes the data read from the external SDRAM to forward it to the corresponding channel.

For FIFO level control, the IEMA includes a IEMAC (IEMA Controller) 49 for monitoring, control and scheduling of read operations from the SDRAM. The IEMAC receives the data request signals 51 from the communication channels and sends the appropriate read requests 52 to the SDRAM controller 13 using a channel look-up table 53 and a SDC write address control block 54. The IEMAC is also coupled to a time base control block 55 to interface read timing control signals with the SDC.

The read side as shown in FIG. 3 is similar to the write side of FIG. 2 except that read commands are used instead of write commands. The read commands are generated based on a communication channel's capability to receive data from the external memory (SDRAM). Channels assert data request signals 51, for example, fcbb3_data_req (Fiber Channel BB3) or etnet_data_req (Ethernet) depending on the kind of channel being used. The data request signals are monitored at the control side of the IEMAC block 49. As long as a data request from a channel has not been served, it may remain asserted and be interpreted as a read command for that channel.

Similar to the write portion, these read commands may be captured at the beginning of the partition cycle, so that the data read can be re-assembled when multiple partitions are associated with a channel. Note that read commands are generated independently from write commands. The data request signals are asserted by a channel when the data channel is able to receive as many data bursts as there are partitions associated with it.

In one embodiment, a partition is granted read access to the external memory if, for the associated channel, a) there is enough data stored in the external memory, b) the captured read command is asserted, c) the partition count matches the partition to execute the access, d) the partition is configured as active, and e) a read request command is received from the SDC block. Any one or more of these conditions may be deleted and others may be added. In one embodiment, when all these conditions are met, the channel ID from the look up table is used to extract the channel base address to be used for the read operation. Then the corresponding control signals and address lines are forwarded to the SDC block, which adapts the signals and executes the read operation from the external memory.

The SDC block keeps a history of the partition read operations. When a read is performed it captures the data from external memory and gives it to the data portion of the IEMAC along with control signals and partition references. The data portion of the IEMAC uses the partition reference received from the SDC block to extract the channel ID associated with that partition. The Channel ID is then stored along with the valid control signal and incoming data words in the Conversion FIFO. The Conversion FIFO is used to convert the data bus width from 144 bits back to 72 bits. On the read side of the Conversion FIFO, the information is extracted and sent to the corresponding channel.

Finally, note that if the write and read portions are symmetrical, the same look up table 18, 53 may be used in every stage (OEMA, control side of IEMA and data side of IEMA) reducing the amount of logic required. For a system in which the number of partitions is 8, the look up table may be implemented using flip-flops, allowing every stage to access the table at the same time. However if the number of partitions increases, RAMs may be desired for the table. RAM tables may introduce conflicts accessing the table from the different stages and multiple copies of the table may be required.

In the example described herein eight partitions are used. However, the number of partitions can be increased. By using more partitions, the granularity may be reduced and the total usable bandwidth may be better divided among different channels. Changes in the number of partitions can be accommodated by changing the number of entries in the look up table.

In the present description, data bursts input to the EMA block are evenly distributed over time on each channel. No one channel sends a greatly larger number of consecutive data bursts to the EMA block. This may cause the BAS FIFO in the OEMA block may overflow. If such uneven operation is expected, then the assignment of partitions may be adjusted to accommodate the irregular flows of data. In addition, in the example tables, the number of partitions is bigger or equal to the number of channels. If more channels are to be connected, then the partitions may be made smaller, so that each channel may receive a partition. Alternatively, a partition for slow channels may have more than one slow channel assigned to it. This may require a technique to distinguish the two different data portions for the one channel.

Further, the number of partitions in the above description is a multiple of four, e.g. 8. Assigning the number of partitions to be a power of 2ⁿ with n >1 meets this condition. Restricting the number of partitions to a multiple of four allows the partition accesses to be optimized with a four bank interleaving technique. In order to interleave memory accesses, at least two different banks are typically required, so the number of partitions may alternatively be a multiple of two. With other types of interleaving approaches, the number of partitions may be a multiple of some other number. Alternatively, if interleaving is not used, then this restriction would not apply.

The described system above is simpler because the same look-up table is used for all stages of the process (OEMA, control and data side of IEMA). A single table works well if the channels all have symmetrical bandwidth. In other words, if the data rate in the write portion is the same as in the read portion. If the channels are not symmetrical, then a different table may be used for input and output so that the SDRAM bandwidth is maximized in both circumstances.

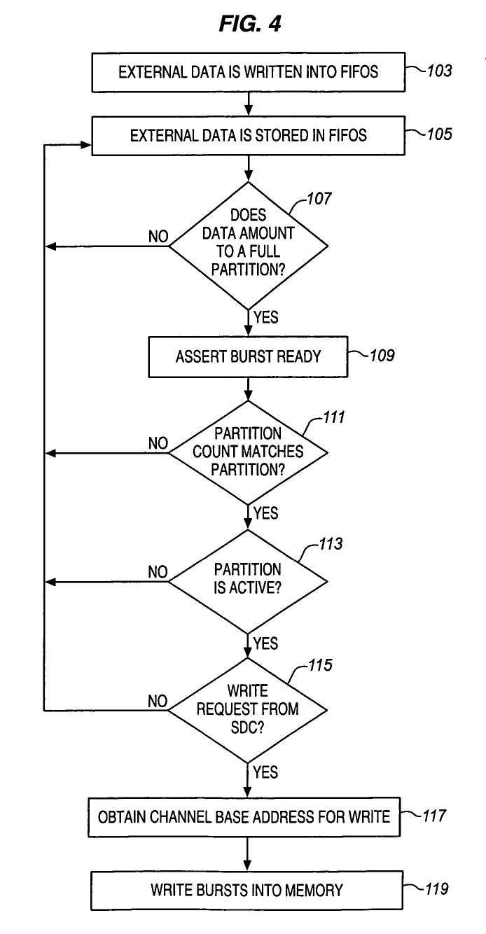

FIG. 4 presents aspects of the described embodiments of the invention as a process flow. In FIG. 4, at block 103, external data flows from the channels and is written into memory buffers, such as FIFOs. The external data is stored in the buffers at block 105. At block 107, the status of the buffers is monitored and various tests are applied, as described above. The test are used to determine whether the amount of data stored in a buffer for a particular channel amounts to a full partition. The partition is a predefined amount of memory that has been chosen based on the nature of an external memory and of the channels. As described above, the external memory will be divided into some number of partitions and, in the above examples, each partition is assigned to a single data channel. If the data amounts to a full partition, then a burst ready signal is asserted at block 109. If it is not yet a full partition, then the tests continue as the data continues to stream in.

At block 111, after the burst ready signal has asserted to the IEMAC, the signal may be used to initiate a number of tests. At block 111, the partition count of the data request is tested to determine if it matches the count of a partition. At block 113, the partition is tested to determine whether it is active. This can be determined, for example by reference to the look-up table which may store a partition status field. Finally, at block 115, it may be determined whether there is a write request from the controller for the external memory. If any of these tests are failed, then the data burst is not written and the data waits in the buffer until the next cycle.

On the other hand, if the tests are satisfied, then the write request may be used as a timing signal, indicating the timing for sending the data and that the external memory is ready. The nature of these signals will depend upon the protocols used by the memory for communicating such status. Upon receiving the write request, or before, a channel base address is obtained at block 113. This may come from a channel look up table like those described above, or from RAM tables or may be generated in logic.

The channel base address reflects an allocation scheme for the external memory that accommodates the different bandwidth requirements of different channels. At block 115, using the obtained channel base address, the ready burst or burst may be written into memory. In one example, writing one burst starts a process of cycling through all of the partitions and writing a burst for each partition for which a burst is ready. By mapping the partitions appropriately, all of the partitions may be serviced very efficiently. The additional time required to service partitions which have no new data may have little or no impact on the overall write time.

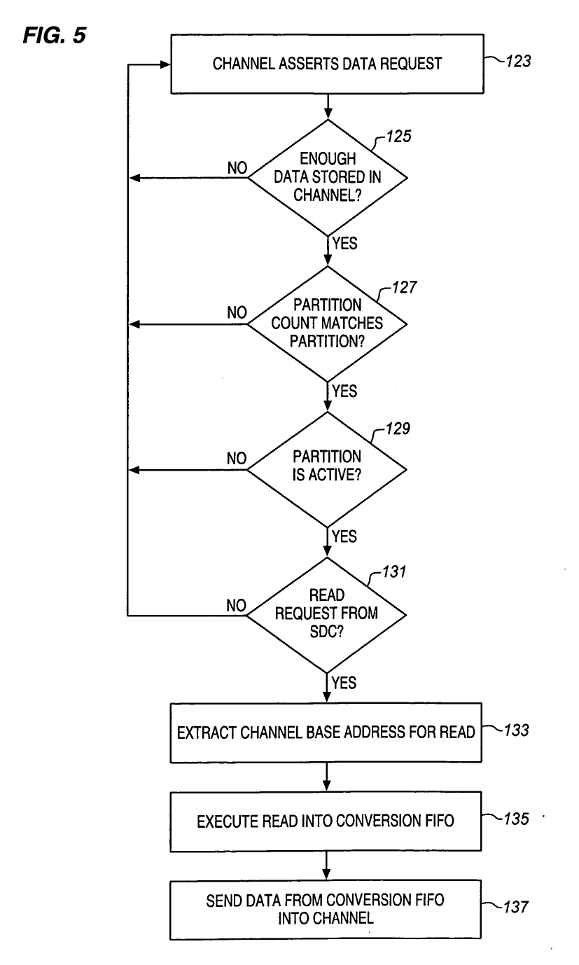

FIG. 5 shows a process flow that may be applied to providing data from the external memory to the data channels. In FIG. 5, at block 123, a data channel asserts a data request. This data request may be used to initiate a number of tests. At block 125, it is determined whether enough data has been stored in the partition for the channel to fill a channel burst. At block 127, the partition count of the data request is tested to determine if it matches the count of a partition. At block 129, the partition is tested to determine whether it is active. This can be determined, for example by reference to the look-up table which may store a partition status field. Finally, at block 129, it may be determined whether there is a read request from the controller for the external memory. If any of these tests are failed, then the data request is not fulfilled and the process may return to wait for another data request.

On the other hand, if the tests are satisfied, then the channel base address for the read operation may be extracted from the look-up table at block 133. The read may then be executed to move the data from the external memory into a conversion buffer at block 135. The data may then be converted as appropriate for the data channel and at block 137, the data may be sent from the conversion buffer into the channel. The tests of FIG. 5 are provided as examples and are not intended to restrict variations and modifications that may be appropriate to adapt to particular situations.

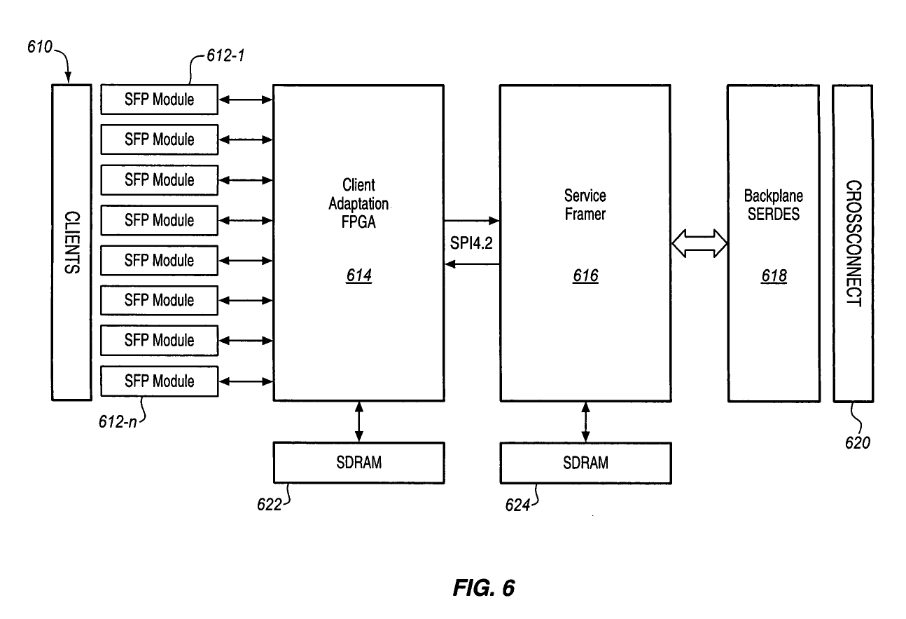

As shown in FIG. 6 the present invention may be applied to long-distance fiber-optic and other communication networks. In FIG. 6 a plurality of clients 610 are connected using SFP (Small Form Factor Pluggable) or XFP modules 612-1 to 612-n. As mentioned above, the clients may be Gigabit Ethernet, Fiber Channel, SONET, or any of a variety of other types using different data rates and different protocols. SFP and XFP modules typically operate as optical transceivers independent of any particular protocol and so are convenient when different clients may be connected. However, protocol-specific connectors or connectors for other types of physical channels may be used instead. For example, copper SFP modules may be used. The SFP modules are coupled to a client adaptation FPGA (Field Programmable Gate Array) 614 that may contain the various components described above with respect to FIGS. 1, 2, and 3. The external memory discussed in FIGS. 1, 2, and 3 is shown in FIG. 6 as SDRAM 622. The components or modules of the FPGA may be embodied in hardware, firmware or software. An FPGA implementation may be preferred for many applications, but the invention is not so limited.

The client adaptation module is coupled using, for example, SPI (System Packet Interface) to a service framer 616 to frame the data from the adaptation module for transmission on other communications hardware. The service framer is coupled through a backplane SERDES (Serializer Deserializer) 618 to a STS (Synchronous Transport Signal) Cross connect 620. The framer has its own external SDRAM 624. The crossconnect may allow for switching, routing, repeating, converting or a number of other functions to be performed in the overall system context. The system architecture of FIG. 6 also allows signals of different sizes and protocols to be aggregated into a multiple service framed communications protocol, such as SONET. Such a device may be useful in combining all the channels for transmission over a long distance fiber communications network.

A lesser or more equipped memory buffer, access controller, adaptation module, external memory, process flow, or network processor than the examples described above may be preferred for certain implementations. Therefore, the configuration and ordering of the examples provided above may vary from implementation to implementation depending upon numerous factors, such as the hardware application, price constraints, performance requirements, technological improvements, or other circumstances. Embodiments of the present invention may also be adapted to other types of data flow formats and protocols and hardware configurations than the examples described herein.

Embodiments of the present invention may be provided as a computer program product which may include a machine-readable medium having stored thereon instructions which may be used to program a general purpose computer, mode distribution logic, memory controller or other electronic devices to perform a process. The machine-readable medium may include, but is not limited to, floppy diskettes, optical disks, CD-ROMs, and magneto-optical disks, ROMs, RAMs, EPROMs, EEPROMs, magnet or optical cards, flash memory, or other types of media or machine-readable medium suitable for storing electronic instructions. Moreover, embodiments of the present invention may also be downloaded as a computer program product, wherein the program may be transferred from a remote computer or controller to a requesting computer or controller by way of data signals embodied in a carrier wave or other propagation medium via a communication link (e.g., a modem or network connection).

In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known circuits, structures and techniques have not been shown in detail to avoid obscuring the understanding of this description.

While the embodiments of the invention have been described in terms of several examples, those skilled in the art may recognize that the invention is not limited to the embodiments described, but may be practiced with modification and alteration within the spirit and scope of the appended claims. The description is thus to be regarded as illustrative instead of limiting.

What is claimed is:

1. A method comprising:
receiving data from a data communications channel;
storing the data in a buffer;
upon accumulating a predefined amount of data from the channel, determining a base address of a partition of a memory associated with the data communications channel; and
storing a burst of the stored data in the memory partition.

2. The method of claim 1, wherein determining a base address comprises applying an identification of the data communications channel to a look up table.

3. The method of claim 1, wherein the partition is assigned to the data communications channel and wherein other partitions of the memory are assigned to other data communications channels.

4. The method of claim 3, wherein the number of partitions assigned to a data communication channel depends upon the data rate of the data communications channel.

5. The method of claim 1, wherein storing a burst of the data comprises addressing each partition of the memory in sequence and storing a burst of the stored data in each partition for which a burst of data is available.

6. The method of claim 1, wherein each burst of data corresponds to a data communications channel.

7. The method of claim 1, further comprising:
receiving a data request from the data communications channel;
determining a channel base address to a partition of a memory associated with the data communications channel;
reading a data burst from the memory using the channel base address; and supplying the read data burst to the channel.

8. The method of claim 1, wherein supplying the read data burst comprises supplying the read data burst through a conversion buffer to convert word sizes of the data from a size for the memory to a size for the data channel.

9. An apparatus including a machine-readable medium having instructions which when executed by a machine cause the machine to perform operations comprising:
receiving data from a data communications channel;
storing the data in a buffer;
upon accumulating a predefined amount of data from the channel, determining a base address of a partition of a memory associated with the data communications channel; and
storing a burst of the stored data in the memory partition.

10. The medium of claim 9, wherein the partition is assigned to the data communications channel, wherein other partitions of the memory are assigned to other data communications channels, and wherein the number of partitions assigned to a data communication channel depends upon the data rate of the data communications channel.

11. The medium of claim 9, wherein the operations further comprise:
receiving a data request from the data communications channel;
determining a channel base address to a partition of a memory associated with the data communications channel;
reading a data burst from the memory using the channel base address; and supplying the read data burst to the channel.

12. An apparatus comprising:
an input buffer to receive data from a plurality of different data communication channels;
a buffer level control to determine whether a predefined amount of data has been received from a particular communications channel;
a look up table to determine a base address to store a burst of the received data in a partition of a memory, the partition being associated with one of the plurality of different data communication channels; and
a controller to store a burst of the received data in the partition of the memory based on the base address.

13. The method of claim 12, wherein the look up table maps a number of partitions to channels based on the data flow rate of each channel.

14. The method of claim 12, wherein the predefined amount of data corresponds to an amount of data in a write sequence of the memory.

15. The method of claim 12, wherein the controller further receives an indication from the buffer level control that the predefined amount of data has been received, receives the base address from the look up table, and schedules write cycles for each partition into the memory, the write cycles cycling through the partitions in a sequence.

16. The method of claim 12, further comprising an output buffer to receive data from the memory;
a read controller to indicate when a data communications channel is ready to receive data; and
an input controller coupled to the look up table obtain base addresses corresponding to the data communications channels and to schedule read cycles from the memory based on indications from the read controller.

17. The method of claim 12, further comprising a conversion buffer to convert words read from the memory by the input controller to a format appropriate for the data communications channel.

18. A high speed data communications network processor for receiving data from different data channels at different data rates, the processor comprising:
a plurality of input transceivers to receive data from each of the different data channels;
an adaptation module to receive the data from the transceivers, the adaptation module including an input buffer to receive the data from the data from the transceivers, a buffer level control to determine when the received data for each transceiver has reached a level corresponding to a write cycle of a memory, a look up table to determine a base address to store a burst of the received data in a partition of the memory, and a controller to store a burst of the received data in the partition of the memory based on the base address; and
a service framer coupled to the adaptation module to reframe data from the adaptation module to conform to a particular service.

19. The processor of claim 18, wherein the controller schedules write cycles to each partition based on a signal received from the buffer level control.

20. The processor of claim 18, wherein the look up table maps a number of partitions to channels based on the data flow rate of each channel.
